(19) United States
(12) Patent Application Publication
(10) Pub. No.: US 2008/0316877 A1
(43) Pub. Date: Dec. 25, 2008

(54) Control Method for an Optical Drive with Different Bandwidths

(75) Inventors: Jacobus Anthonie Wisse, Eindhoven (NL); Stefan Geusens, Houthalen (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/097,567

(22) PCT Filed: Dec. 8, 2006
(86) PCT No.: PCT/IB06/54705

§ 371 Date: Jun. 16, 2008

(30) Foreign Application Priority Data
Dec. 19, 2005 (EP) 05112363.6

(51) Int. Cl. G11B 7/00

(52) U.S. Cl. 369/44.14; G9B/7

(57) ABSTRACT

The present invention discloses a method for controlling the position of a radiation beam on an optical carrier (1), e.g. a CD, a DVD, a HD-DVD or a BD disc, in an optical drive. Initially, the optical pickup unit (OPU) is fixated relative to the optical carrier and there is established a closed-loop control—so-called capture—in response to an error signal e.g. radial or focus error tracking signal (FE, RE). Then, by servo control means (9, 50) a first bandwidth (BW1) is set in a stabilization period (SP), and subsequently a second bandwidth (B W2) of the servo control means is set. The second bandwidth (B W2) is lower than the first bandwidth (BW1). The invention applies bandwidth switching and thereby provides a more robust operation of the optical drive, as the first and second bandwidths may be separately optimised. Additionally, the power consumption of the optical pickup unit (OPU) may be reduced.

The present invention relates to a method for controlling the position of a radiation beam on an optical carrier, e.g. a CD, a DVD, a HD-DVD or a BD disc, in an optical drive, said optical drive comprising servo control means. The invention also relates to a corresponding optical drive, corresponding processing means, and a corresponding computer program product.

In optical drives for recording and reproducing of information or data from an optical disc, a servo system is applied for keeping a focused beam of e.g. laser light from an optical pickup unit (OPU) on a desired track of the optical disc. The servo system allows the laser light to accurately follow the tracks on the optical disc to ensure a reliable recording of data in the tracks or a stable readout of data from the tracks. A few well-known radial control methods include the push-pull (PP) method for rewriteable/recordable optical discs with guide grooves, so-called pre-grooves, and the differential phase detection (DPD) method for optical discs of the read-only memory (ROM) format.

The optical drive typically comprises a focusing lens that is movable by a bi-axial fine-tuning actuator in a focusing direction and in a radial direction so as fine adjust, respectively, the focal position and the radial position of the laser light on the optical disc. For some optical drives rotation is possible around a tangential axis of the disc so as to compensate for tilt across the disc in the radial direction—this is known as the umbrella defect. Notice, that radial movement of the OPU performs the coarse adjustment of the laser position on the disc. Thus, this radial and focal servo control is a dynamic control system that needs to be understood for stable and reliable operation of the optical drive.

Like most physical closed-loop control systems the radial and focal servomechanism of an optical drive has a well-known low pass behavior as frequency response. For example, the radial servomechanism of an optical drive may be characterized by a certain radial bandwidth, typically in the order of 5-10 kHz for e.g. high-speed DVD and high-speed modes like 48×CD and 4×BD, above which the radial servomechanism is unstable. The required bandwidth of the servo loop depends on the specifications of the optical disc, the allowed residual error during reading/writing, the eccentricity of the disc, acceleration errors of the disc, the rotational speed of the disc in the drive, disc defects (black dots, scratches, fingerprints), etc. As the allowed residual error is related to the track pitch on the disc, the allowed residual error of the actual position on the disc has been constantly decreasing over time, which—in turn—requires a higher and higher bandwidth, the bandwidth being a measure of the speed of response of the control system.

However, the achievable bandwidths are limited by the mechanical design of the optical drive; i.e. the effective spring and damping constants of the actuator configuration. The mechanical design therefore imposes upper limits to the bandwidths that are possible for a stable control system. Thus, a compromise has to be made between the highest possible level of a bandwidth and yet a stable bandwidth for the control system in question. After having found a compromise value of the bandwidth, this bandwidth value should be maintained by the control system.

U.S. Pat. No. 6,157,601 discloses an auto gain adjustment procedure for an optical drive that is capable of adjusting the gain of a focus/radial control system so as to compensate for internal changes of mechanical/optical properties of the optical drive before disc access operations of the optical drive. The gain of most control systems is the primary factor for determining the bandwidth of the frequency response. Thus, the bandwidth may—in turn—be adjusted but during disc access operations the bandwidths of the focus and radial control systems are still maintained constant. Therefore, this procedure also has a compromise bandwidth value. For some operation conditions of the optical drive the performance is therefore not optimal, e.g. an initial velocity difference (either radial or perpendicular to the disc) between the laser spot and the disc may not be damped sufficiently fast resulting in loss of tracking, or the control system may be inherently unstable, both results being highly undesirable.

Hence, an improved method for controlling the position of a radiation beam on an optical carrier would be advantageous, and in particular a more efficient and/or reliable method would be advantageous.

Accordingly, the invention preferably seeks to mitigate, alleviate or eliminate one or more of the above mentioned disadvantages singly or in any combination. In particular, it may be seen as an object of the present invention to provide a method that solves the above mentioned problems of the prior art with optimal performance of a control system of an optical drive.

This object and several other objects are obtained in a first aspect of the invention by providing a method for controlling the position of a radiation beam on an optical carrier in an optical drive, said optical drive comprising:

an optical pickup unit (OPU), said unit comprising radiation means capable of emitting a radiation beam,

servo control means for controlling the position of the radiation beam on the carrier in response to an error signal said error signal being indicative of a difference between a target position and an actual position of the radiation beam on the optical carrier,

the method comprising the steps of:

1) fixating the optical pickup unit (OPU) relative to the optical carrier,
2) establishing a closed-loop control in response to said error signal after fixating the optical pickup unit (OPU),
3) setting a first bandwidth (BW1) of the servo control means in a stabilization period (SP), and
4) setting a second bandwidth (BW2) of the servo control means after said stabilization period (SP), said second bandwidth (BW2) being lower than said first bandwidth (BW1).

The invention is particularly, but not exclusively, advantageous for providing an optical drive having two different bandwidths, an initial first bandwidth being higher than a subsequent bandwidth, and therefore both the first and the second bandwidths may separately be optimized. This is quite different from the prior art solutions hitherto applied where a compromise bandwidth is chosen, this compromise value having non-optimal performance for the different state of operation for the optical drive. Thus, according to the present invention just after establishing a closed-loop control in response to the error signal, e.g. radial error signal or focus error signal, a first high bandwidth is set in order to provide fast and efficient minimising or damping of the velocity and position error signal of the radiation beam. The first high bandwidth may optionally be set before the closed-loop control is established, i.e. the control loop being closed. After a stabilization period (SP), the bandwidth of the servo control means is lowered to a second bandwidth being lower than the first bandwidth. In this way, a more robust method for operation of the optical drive is provided. Additionally, the power dissipation of the optical pickup unit, in particular power dissipation of the actuation means of the lens system, may be lowered due to the separately optimised bandwidths.

Step 2) of the present invention is also known in the art as a so-called “capture”, i.e. “radial capture” or “focus capture”, whereby it is to be understood that after capture the servo control means by a closed loop control process (via the error signal) has sufficient control of the position of the radiation beam. This control of the radiation beam may be prevailing during step 3) and step 4) of the present invention.

Typically, the optical pickup unit (OPU) may be fixated after a coarse or rough movement of the optical pickup unit (OPU). The meaning of the term “coarse” is to be considered relative the movement performed by the lens system within the optical pickup unit. The fixation may be performed by turning off appropriate actuation means mechanically connected to the optical pickup unit. The actuation means for displacing the OPU are also known in the art as so-called macro moving means as opposed to the micro moving means within the OPU.

In an embodiment, the length of the stabilization period (SP) may be depending on a rate of change of the error signal to make the length adjustable to the need for damping. Thus, a first time derivative of the error signal or a measure thereof may be applied to adapt the length of the stabilization period (SP). The first time derivative of the error signal may be equivalent to a relative velocity signal for the corresponding positional error. Optionally, higher order time derivatives of the error signal may be applied, e.g. a measure of the acceleration of the positional error. Alternatively or additionally, a magnitude of the error signal may be applied for adjustment of the length of the stabilization period (SP), e.g. an upper and/or a lower limit may be pre-set above and/or below which a certain length of the stabilization period (SP) may be imposed. This may be implemented by a look-up-table in the optical drive. The length of the stabilization period (SP) may be in the interval of 5-500 microseconds, 50-400 microseconds, 100-300 microseconds, or 150-250 microseconds. Appropriate values of the stabilization period (SP) may be 50, 100, 150, 200, 250, 300, 350, 400, 450 or 500 microseconds.

In another embodiment, the value of the first bandwidth (BW1) of the servo control means in the stabilization period (SP) may be depending on a rate of change of the error signal in order to provide a dynamic damping. Thus, a first time derivative of the error signal or a measure thereof may be applied to adapt the value of the first bandwidth (BW1) of the servo control means in the stabilization period (SP). Optionally, higher order time derivatives of the error signal may be applied, e.g. a measure of the acceleration of the positional error. Alternatively or additionally, a magnitude of the error signal may be applied for adjustment of the value of the first bandwidth (BW1) of the servo control means in the stabilization period (SP), e.g. an upper and/or a lower limit may be pre-set above and/or below which a certain value of the first bandwidth (BW1) of the servo control means may be imposed. This may be implemented by a look-up-table in the optical drive. The value of the first bandwidth (BW1) of the servo control means in the stabilization period (SP) may be in the interval of 1-20 kHz, 2-15 kHz, 3-10 kHz, or 5-8 kHz. Appropriate values of the first bandwidth (BW1) and/or the second bandwidth (BW2) may be 1, 2, 3, 4, 5, 6, 7, 8, 9, 10, 11, 12, 13, 14, 15, 16, 17, 18, 19 or 20 kHz.

Possibly, the error signal may be a radial error signal for controlling the radial position of the radiation beam on the carrier. Accordingly, the second bandwidth may be depending on the rotational speed of the carrier in order to scale the bandwidth with the rotational speed of the carrier and thereby increase the stability of the control loop during e.g. reading and/or writing.

Possibly, the error signal may be a focus error signal controlling the focus position of the radiation beam on the carrier. Accordingly, the method may additionally comprise the step of setting a third bandwidth of the servo control means, said third bandwidth being different from said second bandwidth. This may be the case after radial capture has taken place. Possibly, the third bandwidth is higher than the second bandwidth of the servo control means to increase the stability of the focus control loop. Additionally, the third bandwidth may be depending on the rotational speed of the carrier in order to scale the bandwidth with the rotational speed of the carrier and thereby increase the stability of the control loop during e.g. reading and/or writing.

In a second aspect, the invention relates to an optical drive capable of reading and/or writing data to an associated optical carrier, said optical drive comprising:

an optical pickup unit (OPU), said unit comprising radiation means capable of emitting a radiation beam,

servo control means for controlling the position of the radiation beam on the carrier in response to an error signal said error signal being indicative of a difference between a target position and an actual position of the radiation beam on the optical carrier,

actuation means for fixating the optical pickup unit (OPU) relative to the optical carrier,

wherein the servo control means is adapted to establish a closed-loop control in response to said error signal after fixating the optical pickup unit (OPU), the servo control means further being adapted for setting a first bandwidth (BW1) of the servo control means in a stabilization period (SP), and setting a second bandwidth (BW2) of the servo control means after said stabilization period (SP), said second bandwidth (BW2) being lower than said first bandwidth (BW1).

In a third aspect, the invention relates to processing means adapted for controlling an associated optical drive, said optical drive comprising:

an optical pickup unit (OPU), said unit comprising radiation means capable of emitting a radiation beam,

servo control means for controlling the position of the radiation beam on the carrier in response to an error signal, said error signal being indicative of a difference between a target position and an actual position of the radiation beam on an optical carrier,

actuation means for fixating the optical pickup unit (OPU) relative to the optical carrier,

wherein the processing means is adapted to establish a closed-loop control in response to said error signal after fixating the optical pickup unit (OPU), the processing means further being adapted for setting a first bandwidth (BW1) of the servo control means in a stabilization period (SP), and setting a second bandwidth (BW2) of the servo control means after said stabilization period (SP), said second bandwidth (BW2) being lower than said first bandwidth (BW1).

The processing means may be a digital processor, an analog processor or a combination thereof. Similarly, the processing means may be sub-divided into separate sub-processors that are electrically connected.

In a fourth aspect, the invention relates to a computer program product being adapted to enable a computer system comprising at least one computer having data storage means associated therewith to control an optical drive according to the first aspect of the invention.

This aspect of the invention is particularly, but not exclusively, advantageous in that the present invention may be implemented by a computer program product enabling a computer system to perform the operations of the first aspect of the invention. Thus, it is contemplated that some known optical drive may be changed to operate according to the present invention by installing a computer program product on a computer system controlling the said optical drive. Such a computer program product may be provided on any kind of computer readable medium, e.g. magnetically or optically based medium, or through a computer based network, e.g. the Internet.

The first, second, third and fourth aspect of the present invention may each be combined with any of the other aspects. These and other aspects of the invention will be apparent from and elucidated with reference to the embodiments described hereinafter.

The present invention will now be explained, by way of example only, with reference to the accompanying Figures, where

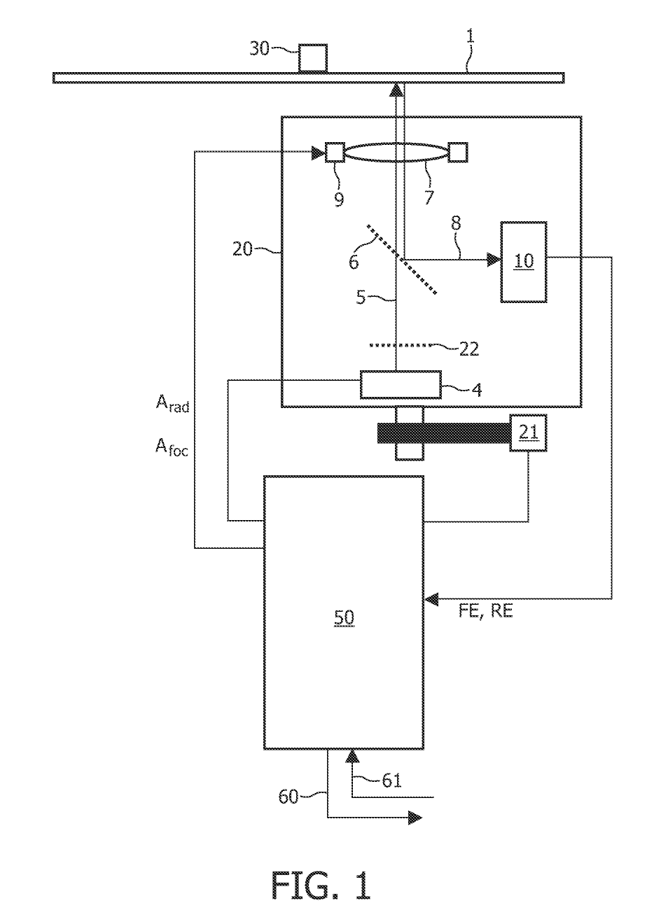

FIG. 1 is a schematic block diagram of an embodiment of an optical drive according to the invention,

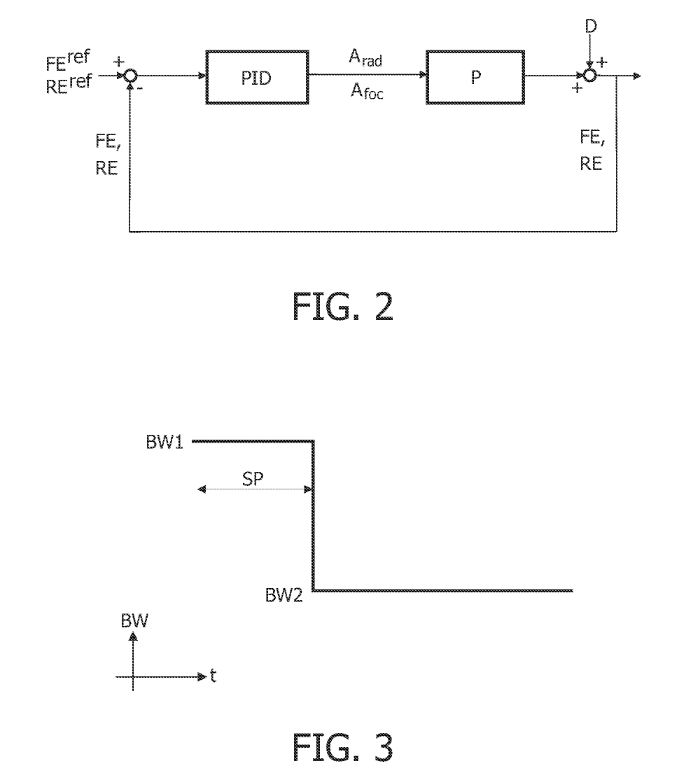

FIG. 2 is a block diagram of a control loop according to the invention,

FIG. 3 is a schematic drawing showing the change of the first and second bandwidths according to the invention,

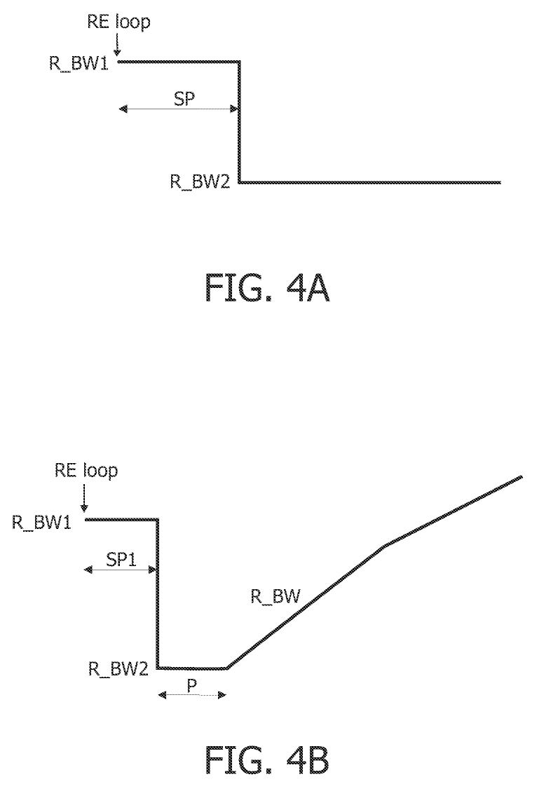

FIG. 4 is a drawing similar to FIG. 3 for a radial embodiment of the invention,

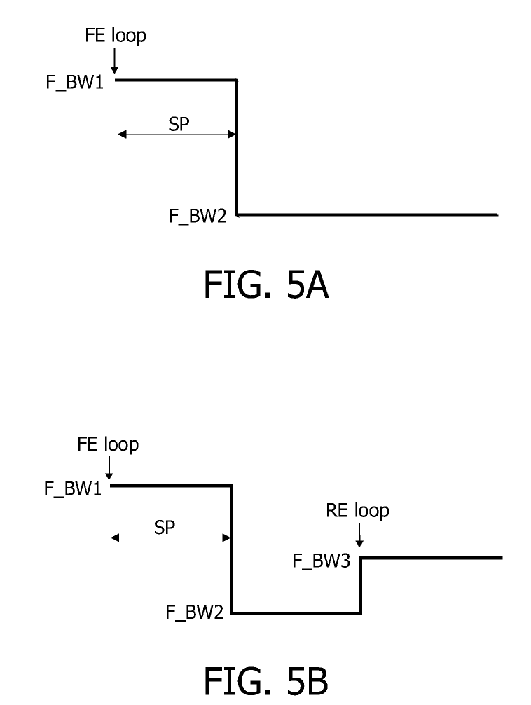

FIG. 5 is a drawing similar to FIG. 3 for a focal embodiment of the invention,

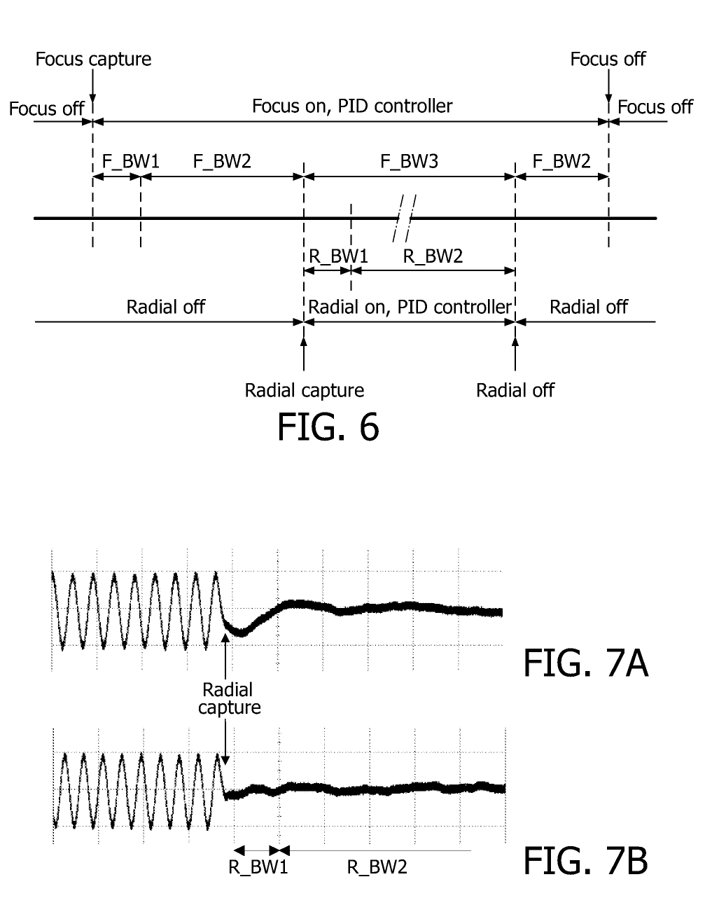

FIG. 6 is a schematic overview for a combined radial and focal embodiment of the invention,

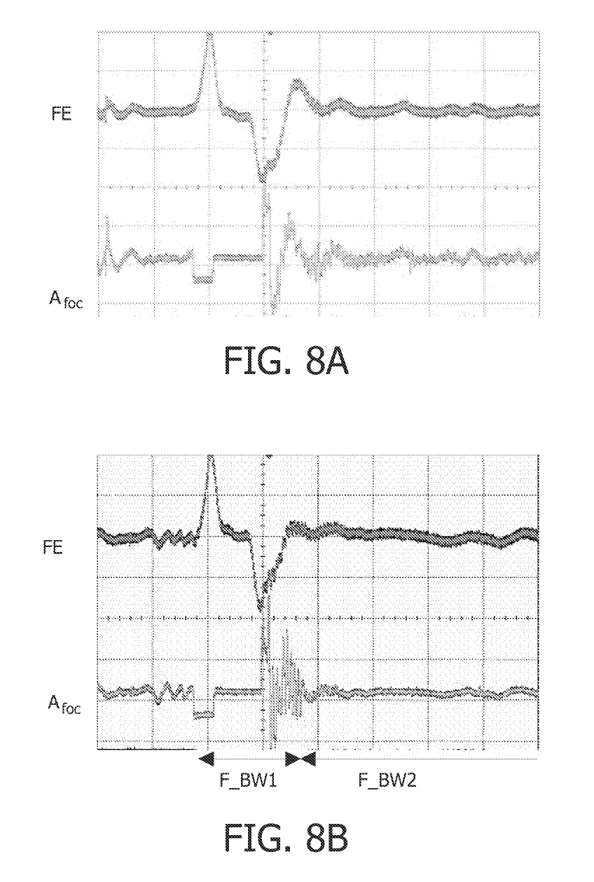

FIGS. 7 and 8 contain graphs with experimental results showing the effects of the invention for a radial capture embodiment and for a focus capture embodiment, respectively, and

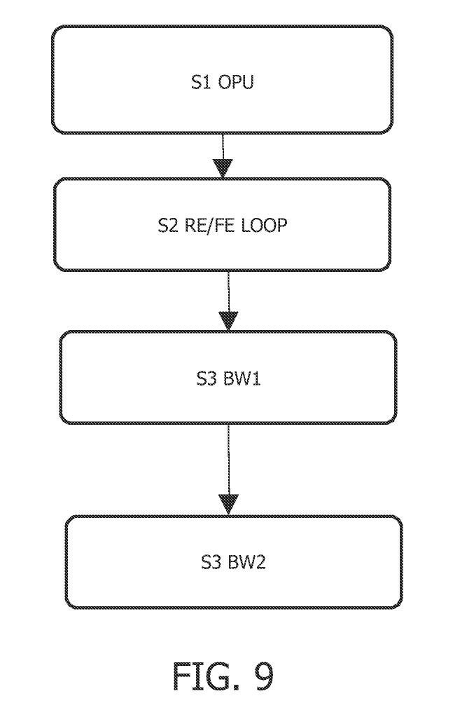

FIG. 9 is a flow-chart of a method according to the invention.

FIG. 1 is a schematic block diagram of an embodiment of an optical drive/apparatus according to the invention. The optical carrier 1 is fixed and rotated by holding means 30.

In an embodiment, the carrier 1 comprises a material suitable for recording information by means of a radiation beam 5. The recording material may be of, for example, the magneto-optical type, the phase-change type, the dye type, metal alloys like Cu/Si or any other suitable material. Information may be recorded in the form of optically detectable regions, also called marks for rewriteable (RW) media and pits for writeable or write-once-read-many media (WORM), on the carrier 1.

In another embodiment, the carrier 1 is of the read-only type, where information or data is read from the carrier 1 but it is not possible to record data on the carrier 1. This type of carrier 1 may have a read-only memory (ROM) format.

The optical drive/apparatus comprises an optical head or optical pick-up (OPU), the optical head 20 being displaceable by actuation means 21, e.g. an electric stepping motor or other electric motors capable of the radially displacing the OPU. The optical head 20 comprises a photo detection system 10, a radiation source 4, a beam splitter 6, an objective lens 7, and lens displacement means 9 capable of displacing the lens 7 both in a radial direction of the carrier 1 and in the focus direction relative to the carrier 1. The lens displacement means 9 may also be adapted for rotating the lens 7 about an axis in a tangential direction of the carrier 1 so as to compensate for umbrella defects of the carrier 1. The optical head 20 may also comprise beam splitting means 22, such as a grating or a holographic pattern capable of splitting the radiation beam 5 into at least three components for use in three-spot differential push-pull radial tracking, or any other applicable control method. For clarity reasons, the radiation beam 5 is shown as a single beam after passing through the beam splitting means 22. Similarly, the radiation 8 reflected may also comprise more than one component, e.g. the three spots and diffractions thereof, but only one beam 8 is shown in FIG. 1 for clarity.

The function of the photo detection system 10 is to convert radiation 8 reflected from the carrier 1 into electrical signals. Thus, the photo detection system 10 comprises several photo detectors, e.g. photodiodes, charged-coupled devices (CCD), etc., capable of generating one or more electric output signals. The photo detectors are arranged spatially to one another and with a sufficient time resolution so as to enable detection of error signals, i.e. focus error FE signals and radial tracking error RE signals. The RE signal may for example be a push-pull PP signal obtained from a two-segmented photo detector. The focus FE and radial tracking error RE signals are transmitted to the processor 50 where a commonly known servomechanism operated by usage of PID control means (proportional-integrate-differentiate) is applied for controlling the radial position and focus position of the radiation beam 5 on the carrier 1 as will be explained in more detail below.

The optical head 20 is optically arranged so that the radiation beam 5 is directed to the optical carrier 1 via a beam splitter 6 and an objective lens 7. Radiation 8 reflected from the carrier 1 is collected by the objective lens 7 and, after passing through the beam splitter 6, falls on a photo detection system 10 which converts the incident radiation 8 to electric output signals as described above.

The processor 50 receives and analyses signals from the photo detection means 10. The processor 50 can also output control signals to the actuation means 21, the radiation source 4, the lens displacement means 9, and the rotating means 30, as schematically illustrated in FIG. 1. Similarly, the processor 50 can receive data, indicated at 61, and the processor 50 may output data from the reading process as indicated at 60. The processor 50 may be a digital processor, an analog processor or a combination thereof. Similarly, the processor 50 may be sub-divided into separate sub-processors (not shown) that are electrically connected. As shown in FIG. 1, the processor 50 in particular receives error signals FE and RE and outputs corresponding control signals A_{foc}, and A_{rad} to the lens displacement means 9 as a part of the control loop capable of controlling the position of the radiation beam 5 on the carrier 1.

FIG. 2 is a schematic block diagram of a control loop according to the invention. The overall principles are known from feedback control for dynamic systems. See e.g. Feedback control of Dynamic Systems, G. F. Franklin et al., 2002, Prentice-Hall Inc. In short, a feedback control loop is established for each of the error signals RE and FE where the measured error signal FE or RE is subtracted from a reference error signal FE^{ref} or RE_{ref}, respectively. Subsequently, this difference signal is transmitted to the proportional-integrate-differentiate control PID, where the signal may be proportionally amplified by a constant, integrated so as to compensate for drift, and/or differentiated so as to compensate for fast transients. Many different PID control settings are possible, but an appropriate output control signal i.e. A_{foc}, or A_{rad} should thereafter be transmitted to the plant P, i.e. the optical drive, in particular the lens displacement means 9. Disturbance to the plant P is denoted by the symbol D.

The bandwidth BW of a feedback control system as shown in FIG. 2 may be found by frequency-response analysis of the system, either analytically or by numerical simulations. The bandwidth BW is normally defined as the maximum frequency at which the output of the system will track an input sinusoid in a satisfactory manner. A more operational definition can also be made from the 3 dB point of the Bode plot. Alternatively, the bandwidth may be defined as the frequency where open-loop gain curve reaches the 0 db intersection. For most PID control settings the dominant factor in determining the bandwidth BW is the proportional gain K of the PID controller. For some models the relationship between the bandwidth BW and the proportional gain K is a simple linear relationship;

BW=BW(K)=a·K+b,

where a and b are constants which depend on the system and model in question. In the context of the present invention, it is therefore to understood that changing of the bandwidth BW may be performed by changing the proportional gain K of the corresponding control loop. Changing the bandwidth BW may, however, also be performed by other means such as changing the integrator action and/or differentiator action of a PID controller, but usually the integrator action has little influence on the bandwidth.

FIG. 3 is schematic drawing showing the change of the first bandwidth BW1 to the second bandwidth BW2 according to the invention. In the lower left corner a coordinate system is shown indicating the direction of time t and magnitude of the bandwidths BW. After fixating the optical pickup unit 20 relative to the optical carrier 1, i.e. after coarse movement of the OPU by the actuator 21, there is established a closed-loop control in response to the error signal FE or RE. Then, during the stabilization period SP a first bandwidth BW1 of the servo control means is set. After the stabilization period SP a second bandwidth BW2 of the servo control means is set, where the second bandwidth BW2 is lower—at least initially—than said first bandwidth BW1. As it will be evident below, the bandwidth of the servo control means may subsequently be increased relative to the value BW2 set just after the stabilization period SP. Possibly, the change from BW1 to BW2 may be a gradual change of the bandwidth.

FIG. 4 is a drawing similar to FIG. 3 for a radial embodiment of the invention. Thus, the error signal is the radial error signal RE indicating a difference between a target position and an actual position of the radiation beam 5 in the radial direction of the optical carrier 1. Establishing a closed-loop control in response to the radial error signal RE or equivalently establishing a radial capture is relevant when changing from one track to another track, either adjacent tracks (single track jump) or several tracks apart when performing a radial seek process.

In FIG. 4A, initially a radial capture has taken place, indicated by the vertical arrow under “RE loop”. During the stabilization period SP, the servo control means for controlling the radial position of the radiation beam 5 on the carrier 1 has the bandwidth R_BW1 as shown in FIG. 4A. After the stabilization period SP the bandwidth of the servo control means for controlling the radial position of the radiation beam 5 is set to the bandwidth R_BW2, where R_BW2 is—at least initially—lower that the bandwidth R_BW1.

The embodiment of FIG. 4B is similar to the embodiment of the FIG. 4A. However, after a period P following the stabilization period SP, the bandwidth R_BW of the radial servo control means is increasing. This may for example occur where the nominal rotation speed of the carrier 1 is increasing, e.g. from 1× to 2× and upwards. In this way, the bandwidth R_BW may even increase above the level of R_BW1. In the embodiment of FIG. 4B, the bandwidth R_BW is shown to increase linearly (with two different rates), but the bandwidth R_BW may as well increase abruptly as the rotation speed of the carrier 1 is increased from e.g. 1× to 2×. For constant linear velocity (CLV) operation of the optical drive the rotational speed (the angular frequency) is changed as a function of the radius of the carrier 1, but the bandwidth R_BW is usually unchanged. Optionally, it may be adjustable.

FIG. 5 is a drawing similar to FIG. 3 of a focus embodiment of the invention. Thus, the error signal is the focus error signal FE indicating a difference between a target position and an actual position of the radiation beam 5 in the focus direction of the optical carrier 1. The carrier 1 may have one layer of information recorded thereon (or be adapted for recording one layer of information) or the carrier 1 may have a multilayer data structure. In the latter case, the irradiation beam 5 should occasionally be re-focussed from one layer to another layer of data—a so-called layer jump—and for that purpose the present invention may in particular find application.

In FIG. 5A, initially a focal capture has taken place, indicated by the vertical arrow under “FE loop”. During the stabilization period SP, the servo control means for controlling the focal position of the radiation beam 5 on the carrier 1 has the bandwidth F_BW1 as shown in FIG. 5A. After the stabilization period SP the bandwidth of the servo control means for controlling the focal position of the radiation beam 5 is set to the bandwidth F_BW2, where F_BW2 is—at least initially—lower that the bandwidth F_BW1.

The embodiment of FIG. 5B is similar to the embodiment of the FIG. 5A. However, after a period following the stabilization period SP radial capture takes place, as indicated by the vertical arrow under “RE loop”, prompting the focal servo control means to increase bandwidth to the bandwidth F_BW3. A conventional radial capture process may be performed, or it may be a radial capture process according to the present invention, i.e. with bandwidth switching from a high level to a lower level. F_BW3 is shown in FIG. 5B to be higher than F_BW2, but it may alternatively also be lower than F_BW2. Similarly, F_BW3 is shown in FIG. 5B to be lower than F_BW1, but it may alternatively be higher than F_BW1. Moreover, F_BW3 may be increased in response to an increase of the rotational speed of the carrier 1 similarly to the radial embodiment shown in FIG. 4B.

FIG. 6 is a schematic overview of the various states of an optical drive for a combined radial and focus embodiment of the invention. This is a particularly advantageous embodiment of the present invention, but the invention may also be implemented solely for a radial capture process or a focal capture process as shown in FIG. 4 and FIG. 5A, respectively.

In FIG. 6, if a focus capture takes place, as indicated by the vertical arrow “Focus capture”, the optical drive changes from a “Focus off” state to a “Focus on” state. Vice versa, the optical drive may change from a “Focus on” to a “Focus off” state when focal capture is lost as indicated by the vertical arrow “Focus off”. Similarly, if a radial capture takes place, as indicated by the vertical arrow “Radial capture”, the optical drive changes from a “Radial off” state to a “Radial on” state. Oppositely, the optical drive may change from a “Radial on” to a “Radial off” state when Radial capture is lost as indicated by the vertical arrow “Radial off”. During a radial capture state “Radial on” and a focus capture state “Focal on” the closed-loop control is performed by the PID controller as indicated also in FIG. 6.

During the different states of the optical drive the bandwidth of the PID controller is changed according to the present invention. Thus, after focus capture in a first stabilization period SP_1 the focal bandwidth F_BW1 is higher than a subsequent bandwidth F_BW2. This is similar to the embodiment shown in FIG. 5. After radial capture the focus bandwidth F_BW2 is changed to F_BW3. After radial capture the radial bandwidth R_BW1 is higher—during a second stabilization period SP_2—than a subsequent bandwidth R_BW2. This is similar to the embodiment shown in FIG. 4. When the optical drive is in the “Radial on” state and the “Focus on” state reading and/or writing of information from/to the carrier 1 is performed. Preferably, reading and/or writing of information is not performed during the second stabilization period SP_2 as transients in the radial position error RE may influence reading and/or writing.

FIGS. 7 and 8 contain graphs with experimental results showing the effects of the invention for a radial capture embodiment and for a focus capture embodiment, respectively.

FIG. 7 shows two graphs, A and B, of the radial error signal RE during a radial seek procedure. The experiment is performed for a DVD disc rotated at 40 Hz. Each of the sinusoidal periods to the left thus represents a track on carrier 1. In graph A, the radial bandwidth is unchanged at 2.8 kHz, and after radial capture transients in the RE signal are clearly visible. In graph B, the radial bandwidth R_BW1 is set at 5.2 kHz for approximately 200 microseconds and afterwards the radial bandwidth R_BW2 is set at 2.8 kHz. Comparing graph A and B, it is apparent that the present invention provides an improved damping of the radial error signal RE.

FIG. 8 shows two graphs, A and B, of the focus error signal FE and the control signal A_{foc} during a layer jump. The experiment is performed for a BD disc. The layer jump is performed by opening the radial control loop and displacing the lens 7 in the focus directions with a so-called acceleration pulse, which may be seen as a short downwards pulse in the A_{foc} signal. In graph A, the focal bandwidth is set constant at 4 kHz during the layer jump and transients in the FE signal are seen after the layer jump. In graph B, the focal bandwidth F_BW1 is set to 5.4 kHz for approximately 200 microseconds and afterwards the focal bandwidth F_BW2 is set to 4 kHz. The transients in the FE signal after the layer jump are seen to be significantly lower and damped faster relative to the transients of graph B.

FIG. 9 is a flow-chart of a method according to the invention. The method comprising the steps of:

S1 OPU: fixating the optical pickup unit OPU relative to the optical carrier 1.

S2 RE/FE LOOP: establishing a closed-loop control in response to said error signal FE or RE, i.e. capture is performed, after fixating the optical pickup unit OPU

S3 BW1: setting a first bandwidth BW1 of the servo control means 9 and 50 in a stabilization period SP.

S4 BW2: setting a second bandwidth BW2 of the servo control means 9 and 50 after said stabilization period SP, said second bandwidth BW2 being lower than said first bandwidth BW1.

Although the present invention has been described in connection with the specified embodiments, it is not intended to be limited to the specific form set forth herein. Rather, the scope of the present invention is limited only by the accompanying claims. In the claims, the term “comprising” does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1. A method for controlling the position of a radiation beam (5) on an optical carrier (1) in an optical drive, said optical drive comprising:
an optical pickup unit (OPU), said unit comprising radiation means (4) capable of emitting the radiation beam (5),
servo control means (9, 50) for controlling the position of the radiation beam (5) on the carrier (1) in response to an error signal (FE, RE), said error signal being indicative of a difference between a target position and an actual position of the radiation beam on the optical carrier (1),
the method comprising the steps of:
1) fixating the optical pickup unit (OPU) relative to the optical carrier (1),
2) establishing a closed-loop control in response to said error signal (FE, RE) after fixating the optical pickup unit (OPU),
3) setting a first bandwidth (BW1) of the servo control means (9, 50) in a stabilization period (SP), and
4) setting a second bandwidth (BW2) of the servo control means (9, 50) after said stabilization period (SP), said second bandwidth (BW2) being lower than said first bandwidth (BW1).

2. A method according to claim 1, wherein the optical pickup unit (OPU) is fixated after a coarse movement of the optical pickup unit (OPU).

3. A method according to claim 1, wherein the length of the stabilization period (SP) is depending on a rate of change of the error signal (FE, RE) and/or a magnitude of the error signal (FE, RE).

4. A method according to claim 1, wherein the value of the first bandwidth (BW1) of the servo control means in the stabilization period (SP) is depending on a rate of change of the error signal (FE, RE) and/or a magnitude of the error signal (FE, RE).

5. A method according to claim 1, wherein the error signal is a radial error signal (RE) for controlling the radial position of the radiation beam (5) on the carrier (1).

6. A method according to claim 5, wherein the second bandwidth (BW2_R) is depending on the rotational speed of the carrier (1).

7. A method according to claim 1, wherein the error signal is a focus error signal (FE) controlling the focus position of the radiation beam (5) on the carrier (1).

8. A method according to claim 7, the method further comprising the step of setting a third bandwidth (F_BW3) of the servo control means, said third bandwidth (F_BW3) being different from said second bandwidth (F_BW2).

9. A method according to claim 8, wherein the third bandwidth (F_BW3) is higher than the second bandwidth (F_BW2) of the servo control means.

10. A method according to claim 8, wherein the third bandwidth (F_BW3) is depending on the rotational speed of the carrier.

11. A optical drive capable of reading and/or writing data to an associated optical carrier (1), said optical drive comprising:
an optical pickup unit (OPU), said unit comprising radiation means (4) capable of emitting a radiation beam (5),
servo control means (9, 50) for controlling the position of the radiation beam (5) on the carrier (1) in response to an error signal (FE, RE), said error signal being indicative of a difference between a target position and an actual position of the radiation beam on the optical carrier,
actuation means (21) for fixating the optical pickup unit (OPU) relative to the optical carrier (1),
wherein the servo control means (9, 50) is adapted to establish a closed-loop control in response to said error signal (FE, RE) after fixating the optical pickup unit (OPU), the servo control means (9, 50) further being adapted for setting a first bandwidth (BW1) of the servo control means in a stabilization period (SP), and setting a second bandwidth (BW2) of the servo control means after said stabilization period (SP), said second bandwidth (BW2) being lower than said first bandwidth (BW1).

12. Processing means (50) adapted for controlling an associated optical drive, said optical drive comprising:
an optical pickup unit (OPU), said unit comprising radiation means capable of emitting a radiation beam,
servo control means (9, 50) for controlling the position of the radiation beam on the carrier in response to an error signal (FE, RE), said error signal being indicative of a difference between a target position and an actual position of the radiation beam on an optical carrier (1),
actuation means (21) for fixating the optical pickup unit (OPU) relative to the optical carrier (1),
wherein the processing means (50) is adapted to establish a closed-loop control in response to said error signal (FE, RE) after fixating the optical pickup unit (OPU), the processing means (50) further being adapted for setting a first bandwidth (BW1) of the servo control means (9, 50) in a stabilization period (SP), and setting a second bandwidth (BW2) of the servo control means (9, 50) after said stabilization period (SP), said second bandwidth (BW2) being lower than said first bandwidth (BW1).

13. A computer program product being adapted to enable a computer system comprising at least one computer having data storage means associated therewith to control an optical drive according to claim 1.
